(19) United States
(12) Patent Application Publication
(10) Pub. No.: US 2025/0373852 A1
(43) Pub. Date: Dec. 4, 2025

(54) TRANSFORM FOR INTRA BLOCK COPY

(71) Applicants: Douyin Vision Co., Ltd., Beijing (CN); Bytedance Inc., Los Angeles, CA (US)

(72) Inventors: Yang Wang, Beijing (CN); Zhipin Deng, Beijing (CN); Kai Zhang, San Diego, CA (US); Li Zhang, San Diego, CA (US)

(21) Appl. No.: 19/302,791

(22) Filed: Aug. 18, 2025

Related U.S. Application Data
(63) Continuation of application No. PCT/CN2024/077696, filed on Feb. 20, 2024.

(30) Foreign Application Priority Data
Feb. 20, 2023 (WO) PCT/CN2023/077178

(51) Int. Cl. H04N 19/61; H04N 19/122; H04N 19/159; H04N 19/176

(52) U.S. Cl. CPC H04N 19/61; H04N 19/122; H04N 19/159; H04N 19/176

(57) ABSTRACT

A mechanism for processing video data is disclosed. The mechanism includes determining to employ a plurality of transforms when applying intra block copy (IBC) to video units. The plurality of transforms may not include discrete cosine transform. A conversion is performed between a visual media data and a bitstream based on the IBC.

### CROSS-REFERENCE TO RELATED APPLICATIONS

This is a continuation of International Patent Application No. PCT/CN2024/077696, filed on Feb. 20, 2024, which claims the priority to and benefits of International Patent Application No. PCT/CN2023/077178, filed on Feb. 20, 2023. All the aforementioned patent applications are hereby incorporated by reference in their entireties.

### TECHNICAL FIELD

The present disclosure relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising: determining to employ a plurality of transforms when applying intra block copy (IBC) to video units; and performing a conversion between a visual media data and a bitstream based on the IBC.

A second aspect relates to an apparatus for processing video data comprising: a processor; and a non-transitory memory with instructions thereon, wherein the instructions upon execution by the processor, cause the processor to perform any of the preceding aspects.

A third aspect relates to a non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

A fourth aspect relates to a non-transitory computer-readable recording medium storing a bitstream of a video which is generated by a method performed by a video processing apparatus, wherein the method comprises: to employ a plurality of transforms when applying intra block copy (IBC) to video units; and generating the bitstream based on the determining.

A fifth aspect relates to a method for storing bitstream of a video comprising: to employ a plurality of transforms when applying intra block copy (IBC) to video units; generating the bitstream based on the determining; and storing the bitstream in a non-transitory computer-readable recording medium.

A sixth aspect relates to a method, apparatus or system described in the present disclosure.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example of nominal vertical and horizontal locations of 4:2:2 luma and chroma samples in a picture.

FIG. 2 illustrates an example encoder block diagram.

FIG. 3 illustrates an example of 67 intra prediction modes.

FIG. 4 illustrates an example of reference samples for wide-angular intra prediction.

FIG. 5 illustrates an example problem of discontinuity in case of directions beyond 45°.

FIG. 6 illustrates an example of an low-frequency non-separable transform (LFNST) process.

FIG. 7 illustrates an example of a region of interest (ROI) for LFNST16.

FIG. 8 illustrates an example of an ROI for LFNST8.

FIG. 9 illustrates an example of matrix-based intra-prediction (MIP) prediction samples to build a histogram of gradients (HoG).

FIG. 10 illustrates an example of sub-block transform (SBT) position, type, and transform type.

FIG. 11 illustrates an example of intra block copy (IBC) reference regions depending on current coding unit (CU) position.

FIG. 12 illustrates examples of symmetry in screen content pictures.

FIG. 13 illustrates example block vector (BV) adjustments for a horizontal flip and a vertical flip.

FIG. 14 illustrates an example of an intra template matching search area.

FIG. 15 illustrates an example spatial part of a convolutional filter.

FIG. 16 illustrates an example a reference area with paddings used to derive filter coefficients.

FIG. 17 illustrates an example of unreconstructed samples in a reference block being padded by copying their prediction samples.

FIG. 18 is a block diagram showing an example video processing system.

FIG. 19 is a block diagram of an example video processing apparatus.

FIG. 20 is a flowchart for an example method of video processing.

FIG. 21 is a block diagram that illustrates an example video coding system.

FIG. 22 is a block diagram that illustrates an example encoder.

FIG. 23 is a block diagram that illustrates an example decoder.

FIG. 24 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Section headings are used in the present disclosure for ease of understanding and do not limit the applicability of techniques and embodiments disclosed in each section only to that section. Furthermore, the embodiments described herein are applicable to other video codec protocols and designs.

### 1. Initial Discussion

This disclosure is related to video coding technologies. Specifically, it is related to transform for intra block copy (IBC), how to and/or whether to apply multiple transform selection (MTS), low-frequency non-separable transform (LFNST), subblock transform (SBT), non-separable primary transform (NSPT) to blocks coded with IBC, and other coding tools in image/video coding. The concepts may be applied to video codecs, such as High Efficiency Video Coding (HEVC), Versatile Video Coding (VVC), or other video coding technologies.

### 2. Video Coding Standards

Video coding standards have evolved primarily through the development of International Telecommunication Union (ITU) telecommunication standardization sector (ITU-T) and International Organization for Standardization (ISO)/International Electrotechnical Commission (IEC) standards. The ITU-T produced H.261 and H.263, ISO/IEC produced motion picture experts group (MPEG)-1 and MPEG-4 Visual, and the two organizations jointly produced the H.262/MPEG-2 Video and H.264/MPEG-4 Advanced Video Coding (AVC) and H.265/HEVC [1] standards. Since H.262, the video coding standards are based on the hybrid video coding structure wherein temporal prediction plus transform coding are utilized. To explore the future video coding technologies beyond HEVC, the Joint Video Exploration Team (JVET) was founded by video coding experts group (VCEG) and MPEG jointly. Many methods have been adopted by JVET and put into the reference software named Joint Exploration Model (JEM). The Joint Video Expert Team (JVET) between VCEG (Q6/16) and ISO/IEC JTC1 SC29/WG11 of MPEG was created to work on the VVC standard targeting a 50% bitrate reduction compared to HEVC.

### 2.1 Color Space and Chroma Subsampling

Color space, also known as the color model (or color system), is a mathematical model which describes the range of colors as tuples of numbers, for example as 3 or 4 values or color components (e.g., red, green, blue (RGB)). Generally speaking, a color space is an elaboration of the coordinate system and sub-space. For video compression, the most frequently used color spaces are luma, blue difference chroma, and red difference chroma (YCbCr) and RGB.

YCbCr, Y′CbCr, or Y Pb/Cb Pr/Cr, also written as YCBCR or Y′CBCR, is a family of color spaces used as a part of the color image pipeline in video and digital photography systems. Y′ is the luma component and CB and CR are the blue-difference and red-difference chroma components. Y′ (with prime) is distinguished from Y, which is luminance, meaning that light intensity is nonlinearly encoded based on gamma corrected RGB primaries.

Chroma subsampling is the practice of encoding images by implementing less resolution for chroma information than for luma information, taking advantage of the human visual system's lower acuity for color differences than for luminance.

2.1.1 4:4:4

In 4:4:4, each of the three Y′CbCr components have the same sample rate. Thus there is no chroma subsampling. This scheme is sometimes used in high-end film scanners and cinematic post production.

2.1.2 4:2:2

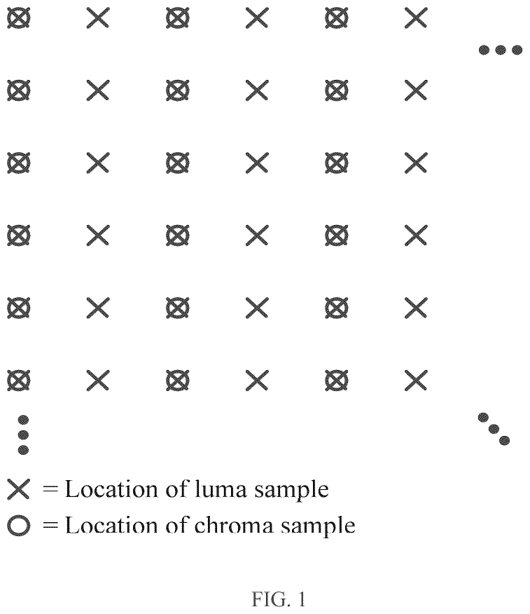

FIG. 1 illustrates an example of nominal vertical and horizontal locations of 4:2:2 luma and chroma samples in a picture. In 4:2:2, the two chroma components are sampled at half the sample rate of luma. The horizontal chroma resolution is halved while the vertical chroma resolution is unchanged. This reduces the bandwidth of an uncompressed video signal by one-third with little to no visual difference. An example of nominal vertical and horizontal locations of 4:2:2 color format is depicted in FIG. 1.

2.1.3 4:2:0

In 4:2:0, the horizontal sampling is doubled compared to 4:1:1, but as the Cb and Cr channels are only sampled on each alternate line in this scheme, the vertical resolution is halved. The data rate is thus the same. Cb and Cr are each subsampled at a factor of 2 both horizontally and vertically. There are three variants of 4:2:0 schemes, having different horizontal and vertical siting.

In MPEG-2, Cb and Cr are cosited horizontally. Cb and Cr are sited between pixels in the vertical direction (sited interstitially). In JPEG/JFIF, H.261, and MPEG-1, Cb and Cr are sited interstitially, halfway between alternate luma samples. In 4:2:0 DV, Cb and Cr are co-sited in the horizontal direction. In the vertical direction, they are co-sited on alternating lines.

TABLE 1
SubWidthC and SubHeightC values derived from
chroma_format_idc and separate_colour_plane_flag

| chroma_{—} | separate_colour_{—} | Chroma | | |
|---|---|---|---|---|
| format_idc | plane_flag | format | SubWidthC | SubHeightC |
| 0 | 0 | Mono- | 1 | 1 |
| | | chrome | | |
| 1 | 0 | 4:2:0 | 2 | 2 |
| 2 | 0 | 4:2:2 | 2 | 1 |
| 3 | 0 | 4:4:4 | 1 | 1 |
| 3 | 1 | 4:4:4 | 1 | 1 |

### 2.2 Example Coding Flow of a Video Codec

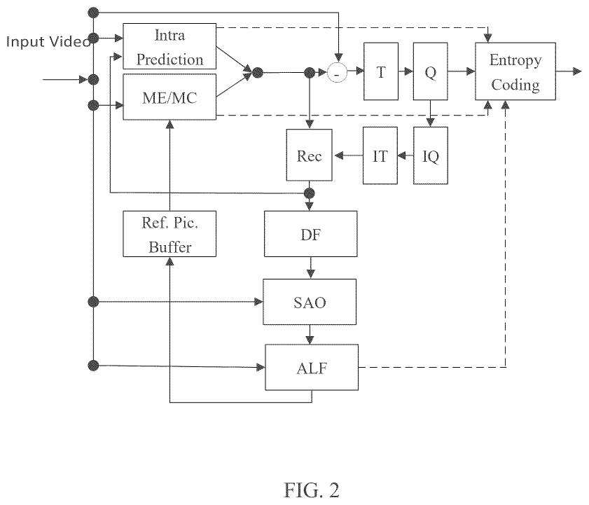

FIG. 2 illustrates an example encoder block diagram. FIG. 2 shows an example of encoder block diagram of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signaling the offsets and filter coefficients. ALF is located at the last processing stage of each picture and can be regarded as a tool trying to catch and fix artifacts created by the previous stages.

2.3 Intra Mode Coding with 67 Intra Prediction Modes

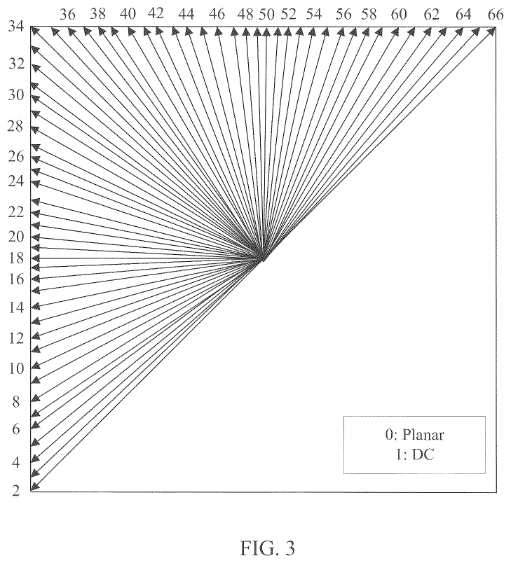

FIG. 3 illustrates an example of 67 intra prediction modes. To capture the arbitrary edge directions presented in natural video, the number of directional intra modes is extended from 33, as used in HEVC, to 65. The additional directional modes are depicted in FIG. 3, and the planar and DC modes remain the same. These denser directional intra prediction modes apply for all block sizes and for both luma and chroma intra predictions.

In the HEVC, every intra-coded block has a square shape and the length of each of the block's sides is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 2.3.1 Wide Angle Intra Prediction

Although 67 modes are defined in the VVC, the exact prediction direction for a given intra prediction mode index is further dependent on the block shape. In some examples, angular intra prediction directions are defined from 45 degrees to −135 degrees in clockwise direction. In VVC, several conventional angular intra prediction modes are adaptively replaced with wide-angle intra prediction modes for non-square blocks. The replaced modes are signaled using the original mode indexes, which are remapped to the indexes of wide angular modes after parsing. The total number of intra prediction modes is unchanged, i.e., 67, and the intra mode coding method is unchanged.

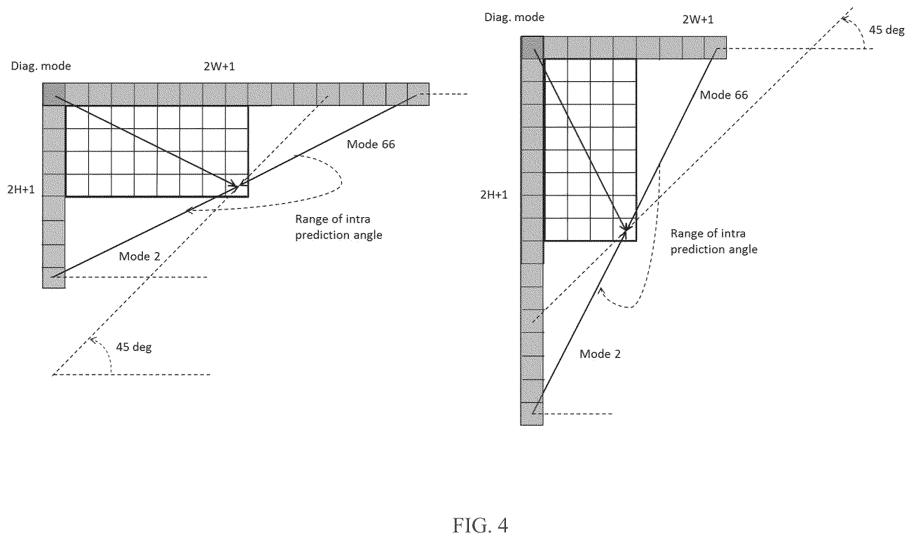

FIG. 4 illustrates an example of reference samples for wide-angular intra prediction. To support these prediction directions, the top reference with length 2W+1, and the left reference with length 2H+1, are defined as shown in FIG. 4. The number of replaced modes in wide-angular direction mode depends on the aspect ratio of a block. The replaced intra prediction modes are illustrated in Table 2.

TABLE 2
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Mode 57, 58, 59, 60, 61, 62, 63, 64, 65, 66 |
| W/H == ⅛ | Modes 55, 56, 57, 58, 59, 60, 61, 62, 63, 64, 65, 66 |
| W/H == 1/16 | Modes 53, 54, 55, 56, 57, 58, 59, 60, 61, 62, 63, 64, |
| | 65, 66 |

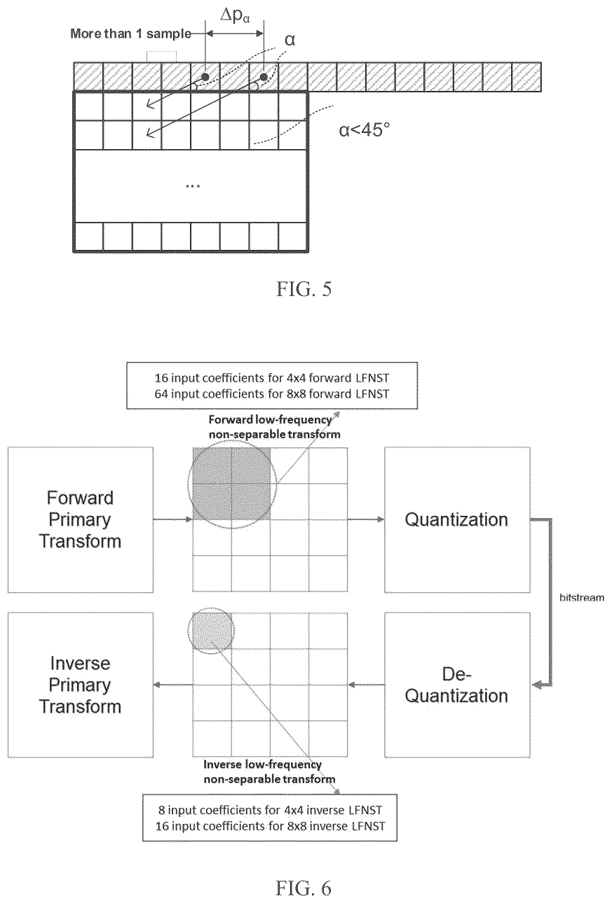

FIG. 5 illustrates an example problem of discontinuity in case of directions beyond 45°. As shown in FIG. 5, two vertically adjacent predicted samples may use two non-adjacent reference samples in the case of wide-angle intra prediction. Hence, low-pass reference samples filter and side smoothing are applied to the wide-angle prediction to reduce the negative effect of the increased gap Δpα. If a wide-angle mode represents a non-fractional offset, there are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed for smoothing is reduced. Besides, this aligns the design of non-fractional modes in the general prediction mode set and wide-angle modes.

In VVC, 4:2:2 and 4:4:4 chroma formats are supported as well as 4:2:0. Chroma derived mode (DM) derivation table for 4:2:2 chroma format was ported from HEVC extending the number of entries from 35 to 67 to align with the extension of intra prediction modes. Since HEVC specification does not support prediction angle below −135 degree and above 45 degree, luma intra prediction modes ranging from 2 to 5 are mapped to 2. Therefore, chroma DM derivation table for 4:2:2 chroma format is updated by replacing some values of the entries of the mapping table to convert prediction angle more precisely for chroma blocks.

### 2.4 Inter Prediction

For each inter-predicted CU, motion parameters include motion vectors, reference picture indices, reference picture list usage index, and additional information used for the new coding feature of VVC to be used for inter-predicted sample generation. The motion parameters can be signaled in an explicit or implicit manner. When a CU is coded with skip mode, the CU is associated with one prediction unit (PU) and has no significant residual coefficients, no coded motion vector delta, and/or reference picture index. A merge mode is specified whereby the motion parameters for the current CU are obtained from neighboring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list, reference picture list usage flag, and other useful information are signaled explicitly per each CU.

### 2.5 Intra Block Copy (IBC)

Intra block copy (IBC) is a tool adopted in HEVC extensions on screen content coding (SCC). This significantly improves the coding efficiency of screen content materials. Since IBC mode is implemented as a block level coding mode, block matching (BM) is performed at the encoder to find the optimal block vector (or motion vector) for each coding unit (CU). Here, a block vector is used to indicate the displacement from the current block to a reference block, which is already reconstructed inside the current picture. The luma block vector of an IBC-coded CU is in integer precision. The chroma block vector rounds to integer precision as well. When combined with adaptive motion vector resolution (AMVR), the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs a rate distortion (RD) check for blocks with either width or height no larger than 16 luma samples. For non-merge mode, the block vector search is performed using hash-based search first. If hash search does not return valid candidate, block matching based local search will be performed.

In the hash-based search, hash key matching (32-bit cyclic redundancy check (CRC)) between the current block and a reference block is extended to all allowed block sizes. The hash key calculation for every position in the current picture is based on 4×4 sub-blocks. For the current block of a larger size, a hash key is determined to match that of the reference block when all the hash keys of all 4×4 sub-blocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current coding tree units (CTUs). At CU level, IBC mode is signalled with a flag and it can be signaled as IBC adaptive motion vector prediction (AMVP) mode or IBC skip/merge mode as follows. IBC skip/merge mode: a merge candidate index is used to indicate which of the block vectors in the list from neighboring candidate IBC coded blocks is used to predict the current block. The merge list comprises spatial, history-based motion vector prediction (HMVP), and pairwise candidates. IBC AMVP mode: block vector difference is coded in the same way as a motion vector difference. The block vector prediction method uses two candidates as predictors, one from left neighbor and one from above neighbor (if IBC coded). When either neighbor is not available, a default block vector will be used as a predictor. A flag is signaled to indicate the block vector predictor index.

### 2.6 Multiple Transform Selection (MTS) for Core Transform

In addition to DCT-II which has been employed in HEVC, a Multiple Transform Selection (MTS) scheme is used for residual coding both inter and intra coded blocks. It uses multiple selected transforms from the DCT8/DST7. The newly introduced transform matrices are DST-VII and DCT-VIII. Table 3 shows the basis functions of the selected DST/DCT.

TABLE 3
Transform basis functions of DCT-II/VIII and DSTVII for N-point input

| Transform Type | Basis function Tᵢ(j), i, j = 0, 1, ... , N − 1 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} )$ |
| | $where , {ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

In order to keep the orthogonality of the transform matrix, the transform matrices are quantized more accurately than the transform matrices in HEVC. To keep the intermediate values of the transformed coefficients within the 16-bit range, after horizontal and after vertical transform, all the coefficients are to have 10 bits.

In order to control MTS scheme, separate enabling flags are specified at sequence parameter set (SPS) level for intra and inter, respectively. When MTS is enabled at SPS, a CU level flag is signalled to indicate whether MTS is applied or not. Here, MTS is applied only for luma. The MTS signaling is skipped when one of the below conditions is applied.
The position of the last significant coefficient for the luma transform block (TB) is less than 1 (i.e., DC only)
The last significant coefficient of the luma TB is located inside the MTS zero-out region

If MTS CU flag is equal to zero, then DCT2 is applied in both directions. However, if MTS CU flag is equal to one, then two other flags are additionally signalled to indicate the transform type for the horizontal and vertical directions, respectively. Transform and signalling mapping table as shown in Table 4. Unified the transform selection for intra sub-partitioning (ISP) and implicit MTS is used by removing the intra-mode and block-shape dependencies. If current block is ISP mode or if the current block is intra block and both intra and inter explicit MTS is on, then only DST7 is used for both horizontal and vertical transform cores. When it comes to transform matrix precision, 8-bit primary transform cores are used. Therefore, all the transform cores used in HEVC are kept as the same, including 4-point DCT-2 and DST-7, 8-point, 16-point and 32-point DCT-2. Also, other transform cores including 64-point DCT-2, 4-point DCT-8, 8-point, 16-point, 32-point DST-7 and DCT-8,use 8-bit primary transform cores.

TABLE 4
Transform and signalling mapping table

| MTS_CU_{—} | MTS_Hor_{—} | MTS_Ver_{—} | Intra/inter | |
|---|---|---|---|---|
| flag | flag | flag | Horizontal | Vertical |
| 0 | | | DCT2 | |
| 1 | 0 | 0 | DST7 | DST7 |
| | 0 | 1 | DCT8 | DST7 |
| | 1 | 0 | DST7 | DCT8 |
| | 1 | 1 | DCT8 | DCT8 |

To reduce the complexity of large size DST-7 and DCT-8, High frequency transform coefficients are zeroed out for the DST-7 and DCT-8 blocks with size (width or height, or both width and height) equal to 32. Only the coefficients within the 16×16 lower-frequency region are retained.

As in HEVC, the residual of a block can be coded with transform skip mode. To avoid the redundancy of syntax coding, the transform skip flag is not signalled when the CU level MTS_CU_flag is not equal to zero. Note that implicit MTS transform is set to DCT2 when LFNST or MIP is activated for the current CU. Also, the implicit MTS can be still enabled when MTS is enabled for inter coded blocks.

### 2.7 Maximum Transform Size and Zeroing-out of Transform Coefficients

Both CTU size and maximum transform size (i.e., all MTS transform kernels) are extended to 256, where the maximum intra coded block can have a size of 128×128. The maximum CTU size is set to 256 for ultra-high definition (UHD) sequences and it is set to 128, otherwise. In the primary transformation process, there is no normative zeroing out operation applied on transform coefficients. However, if LFNST is applied, the primary transform coefficients outside the LFNST region are normatively zeroed out.

### 2.8 Enhanced MTS for Intra Coding

In the current VVC design, for MTS, only DST7 and DCT8 transform kernels are utilized which are used for intra and inter coding.

Additional primary transforms including DCT5, DST4, DST1, and identity transform (IDT) are employed. Also, MTS set is made dependent on the TU size and intra mode information. 16 different TU sizes are considered, and for each TU size 5 different classes are considered depending on intra-mode information. For each class, 1, 4 or 6 different transform pairs are considered. The number of intra MTS candidates are adaptively selected (e.g., between 1, 4, and 6 MTS candidates) depending on the sum of absolute value of transform coefficients. The sum is compared against the two fixed thresholds to determine the total number of allowed MTS candidates:

$$1 candidate \text{:} sum <= th 0$$

$$4 candidates \text{:} th 0 < sum <= th 1$$

$$6 candidates \text{:} sum > th 1$$

Note that, although a total of 80 different classes are considered, some of those different classes often share exactly same transform set. So, there are 58 (less than 80) unique entries in the resultant look-up table (LUT).

For angular modes, a joint symmetry over TU shape and intra prediction is considered. So, a mode i (i>34) with TU shape A×B will be mapped to the same class corresponding to the mode j=(68−i) with TU shape B×A. However, for each transform pair the order of the horizontal and vertical transform kernel is swapped. For example, for a 16×4 block with mode 18 (horizontal prediction) and a 4×16 block with mode 50 (vertical prediction) are mapped to the same class. However, the vertical and horizontal transform kernels are swapped. For the wide-angle modes the nearest conventional angular mode is used for the transform set determination. For example, mode 2 is used for all the modes between −2 and −14. Similarly, mode 66 is used for mode 67 to mode 80.

### 2.9 Inter MTS Optimization

For the MTS of inter-coded CUs, four candidates: {(DST7, DST7), (DST7, DCT8), (DCT8, DST7), (DCT8, DCT8)} are used for every CU. For the larger resolution sequences (width>1080) maximum CU size for Inter-MTS usage is set to 32 (i.e., Inter-MTS is used for CU with width <=32 and height <=32), and for the remaining sequences (smaller resolution) it is set to 16. For 4-pt, 8-pt and 16-pt transforms, the current adaptive multiple transform (AMT) transform cores, i.e., DST-7 and DCT-8, is replaced with separable Karhunen-Loève transforms (KLTs).

### 2.10 Low-Frequency Non-Separable Ttransform (LFNST)

FIG. 6 illustrates an example of an LFNST process. In VVC, LFNST is applied between forward primary transform and quantization (at encoder) and between de-quantization and inverse primary transform (at decoder side) as shown in FIG. 6. In LFNST, 4×4 non-separable transform or 8×8 non-separable transform is applied according to block size. For example, 4×4 LFNST is applied for small blocks (i.e., min (width, height)<8) and 8×8 LFNST is applied for larger blocks (i.e., min (width, height)>4).

Application of a non-separable transform, which is being used in LFNST, is described as follows using input as an example. To apply 4×4 LFNST, the 4×4 input block X

$$X = [ \begin{matrix}{X}_{00} & {X}_{01} & {X}_{02} & {X}_{03} \\ {X}_{10} & {X}_{11} & {X}_{12} & {X}_{13} \\ {X}_{20} & {X}_{21} & {X}_{22} & {X}_{23} \\ {X}_{30} & {X}_{31} & {X}_{32} & {X}_{33}\end{matrix} ] \qquad ( 2 - 1 )$$

is first represented as a vector [symbol] :

$$( 2 - 2 )$$

$$\vec{X} = {[ \begin{matrix}{X}_{00} & {X}_{01} & {X}_{02} & {X}_{03} & {X}_{10} & {X}_{11} & {X}_{12} & {X}_{13} & {X}_{20} & {X}_{21} & {X}_{22} & {X}_{23} & {X}_{30} & {X}_{31} & {X}_{32} & {X}_{33}\end{matrix} ]}^{T}$$

The non-separable transform is calculated as [symbol] =T· [symbol] , where [symbol] indicates the transform coefficient vector, and T is a 16×16 transform matrix. The 16×1 coefficient vector [symbol] is subsequently re-organized as 4×4block using the scanning order for that block (horizontal, vertical or diagonal). The coefficients with smaller index will be placed with the smaller scanning index in the 4×4 coefficient block.

### 2.10.1 Reduced Non-separable Transform

LFNST (low-frequency non-separable transform) is based on direct matrix multiplication approach to apply non-separable transform so that it is implemented in a single pass without multiple iterations. However, the non-separable transform matrix dimension needs to be reduced to minimize computational complexity and memory space to store the transform coefficients. Hence, reduced non-separable transform (or RST) method is used in LFNST. The main idea of the reduced non-separable transform is to map an N (N is commonly equal to 64 for 8×8 NSST) dimensional vector to an R dimensional vector in a different space, where N/R (R<N) is the reduction factor. Hence, instead of an N×N matrix, the RST matrix becomes an R×N matrix as follows:

$${T}_{R \times N} = [ \begin{matrix}{t}_{11} & {t}_{12} & {t}_{13} & … & {t}_{1 N} \\ {r}_{21} & {t}_{22} & {t}_{23} & ⋱ & {t}_{2 N} \\ & ⋮ & & ⋱ & ⋮ \\ {t}_{R 1} & {t}_{R 2} & {t}_{R 3} & ⋯ & {t}_{RN}\end{matrix} ] \qquad ( 2 - 3 )$$

Where the R rows of the transform are R bases of the N-dimensional space. The inverse transform matrix for RST is the transpose of its forward transform. For 8×8 LFNST, a reduction factor of 4 is applied, and 64×64 direct matrix, which is conventional 8×8 non-separable transform matrix size, is reduced to 16×48 direct matrix. Hence, the 48×16 inverse RST matrix is used at the decoder side to generate core (primary) transform coefficients in 8×8 top-left regions. When 16×48 matrices are applied instead of 16×64 with the same transform set configuration, each of which takes 48 input data from three 4×4 blocks in a top-left 8×8 block excluding right-bottom 4×4 block. With the help of the reduced dimension, memory usage for storing all LFNST matrices is reduced from 10 kilobytes (KB) to 8 KB with reasonable performance drop. In order to reduce complexity LFNST is restricted to be applicable only if all coefficients outside the first coefficient sub-group are non-significant. Hence, all primary-only transform coefficients have to be zero when LFNST is applied. This allows a conditioning of the LFNST index signalling on the last-significant position, and hence avoids the extra coefficient scanning in the current LFNST design, which is needed for checking for significant coefficients at specific positions only. The worst-case handling of LFNST (in terms of multiplications per pixel) restricts the non-separable transforms for 4×4 and 8×8 blocks to 8×16 and 8×48 transforms, respectively. In those cases, the last-significant scan position has to be less than 8 when LFNST is applied, for other sizes less than 16. For blocks with a shape of 4×N and N×4 and N>8, the proposed restriction implies that the LFNST is now applied only once, and that to the top-left 4×4 region only. As all primary-only coefficients are zero when LFNST is applied, the number of operations needed for the primary transforms is reduced in such cases. From encoder perspective, the quantization of coefficients is remarkably simplified when LFNST transforms are tested. A rate-distortion optimized quantization has to be done at maximum for the first 16 coefficients (in scan order), the remaining coefficients are enforced to be zero.

### 2.10.2 LFNST Transform Selection

There are a total of 4 transform sets and 2 non-separable transform matrices (kernels) per transform set are used in LFNST. The mapping from the intra prediction mode to the transform set is pre-defined as shown in Table 5. If one of three cross-component linear model (CCLM) modes (INTRA_LT_CCLM, INTRA_T_CCLM or INTRA_L_CCLM) is used for the current block (81<=predModeIntra<=83), transform set 0 is selected for the current chroma block. For each transform set, the selected non-separable secondary transform candidate is further specified by the explicitly signalled LFNST index. The index is signalled in a bit-stream once per Intra CU after transform coefficients.

TABLE 5
Transform selection table

| IntraPredMode | Tr. set index |
|---|---|
| IntraPredMode < 0 | 1 |
| 0 <= IntraPredMode <= 1 | 0 |
| 2 <= IntraPredMode <= 12 | 1 |
| 13 <= IntraPredMode <= 23 | 2 |
| 24 <= IntraPredMode <= 44 | 3 |
| 45 <= IntraPredMode <= 55 | 2 |
| 56 <= IntraPredMode <= 80 | 1 |
| 81 <= IntraPredMode <= 83 | 0 |

2.10.3 LFNST Index Signaling and Interaction with Other Tools

Since LFNST is restricted to be applicable only if all coefficients outside the first coefficient sub-group are non-significant, LFNST index coding depends on the position of the last significant coefficient. In addition, the LFNST index is context coded but does not depend on intra prediction mode, and only the first bin is context coded. Furthermore, LFNST is applied for intra CU in both intra and inter slices, and for both Luma and Chroma. If a dual tree is enabled, LFNST indices for Luma and Chroma are signaled separately. For inter slice (the dual tree is disabled), a single LFNST index is signaled and used for both Luma and Chroma.

Considering that a large CU greater than 64×64 is implicitly split (TU tiling) due to the existing maximum transform size restriction (64×64), an LFNST index search could increase data buffering by four times for a certain number of decode pipeline stages. Therefore, the maximum size that LFNST is allowed is restricted to 64×64. Note that LFNST is enabled with DCT2 only. The LFNST index signaling is placed before MTS index signaling.

The use of scaling matrices for perceptual quantization is not evident that the scaling matrices that are specified for the primary matrices may be useful for LFNST coefficients. Hence, the uses of the scaling matrices for LFNST coefficients are not allowed. For single-tree partition mode, chroma LFNST is not applied.

2.10.4 Secondary Transformation: LFNST Extension with Large Kernel

The LFNST design in VVC is extended as follows:

The number of LFNST sets(S) and candidates (C) are extended to S=35 and C=3, and the LFNST set (IfnstTrSetIdx) for a given intra mode (predModeIntra) is derived according to the following formula:
For predModeIntra<2, IfnstTrSetIdx is equal to 2
IfnstTrSetIdx=predModeIntra, for predModeIntra in [0,34]
IfnstTrSetIdx=68-predModeIntra, for predModeIntra in [35,66]

Three different kernels, LFNST4, LFNST8, and LFNST16, are defined to indicate LFNST kernel sets, which are applied to 4×N/N×4 (N≥4), 8×N/N×8 (N≥8), and M×N (M, N≥16), respectively.

The kernel dimensions are specified by:

$$( LFSNT 4 , LFNST {8}^{*} , LFNST {16}^{*} ) = ( 16 \times 16 , 32 \times 64 , 32 \times 96 )$$

The forward LFNST is applied to top-left low frequency region, which is called Region-Of-Interest (ROI). When LFNST is applied, primary-transformed coefficients that exist in the region other than ROI are zeroed out, which is not changed from the VVC standard.

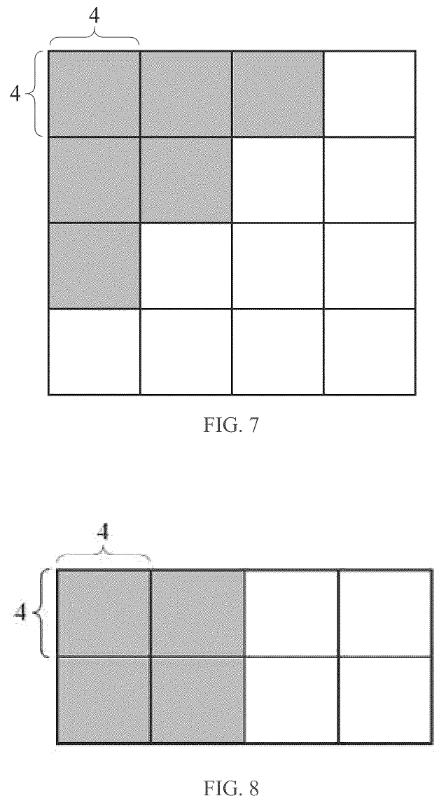

FIG. 7 illustrates an example of a region of interest (ROI) for LFNST16. It comprises six 4×4 sub-blocks, which are consecutive in scan order. Since the number of input samples is 96, transform matrix for forward LFNST16 can be Rx96. R is chosen to be 32 in this contribution, 32 coefficients (two 4×4 sub-blocks) are generated from forward LFNST16 accordingly, which are placed following coefficient scan order.

FIG. 8 illustrates an example of an ROI for LFNST8. The forward LFNST8 matrix can be Rx64 and R is chosen to be 32. The generated coefficients are located in the same manner as with LFNST16. The mapping from intra prediction modes to these sets is shown in Table 6.

TABLE 6
Mapping of intra prediction modes to LFNST set index

| Intra pred. mode | −14 | −13 | −12 | −11 | −10 | −9 | −8 | −7 | −6 | −5 | −4 | −3 | −2 |
|---|---|---|---|---|---|---|---|---|---|---|---|---|---|
| LFNST set index | 2 | 2 | 2 | 2 | 2 | 2 | 2 | 2 | 2 | 2 | 2 | 2 | 2 |

| Intra pred. mode | −1 | 0 | 1 | 2 | 3 | 4 | 5 | 6 | 7 | 8 | 9 | 10 | 11 | 12 | 13 | 14 | 15 | 16 | 17 |
|---|---|---|---|---|---|---|---|---|---|---|---|---|---|---|---|---|---|---|---|
| LFNST set index | 2 | 0 | 1 | 2 | 3 | 4 | 5 | 6 | 7 | 8 | 9 | 10 | 11 | 12 | 13 | 14 | 15 | 16 | 17 |

| Intra pred. mode | 18 | 19 | 20 | 21 | 22 | 23 | 24 | 25 | 26 | 27 | 28 | 29 | 30 | 31 | 32 | 33 |
|---|---|---|---|---|---|---|---|---|---|---|---|---|---|---|---|---|
| LFNST set index | 18 | 19 | 20 | 21 | 22 | 23 | 24 | 25 | 26 | 27 | 28 | 29 | 30 | 31 | 32 | 33 |

| Intra pred. mode | 34 | 35 | 36 | 37 | 38 | 39 | 40 | 41 | 42 | 43 | 44 | 45 | 46 | 47 | 48 | 49 | 50 |
|---|---|---|---|---|---|---|---|---|---|---|---|---|---|---|---|---|---|
| LFNST set index | 34 | 33 | 32 | 31 | 30 | 29 | 28 | 27 | 26 | 25 | 24 | 23 | 22 | 21 | 20 | 19 | 18 |
| Intra pred. mode | 51 | 52 | 53 | 54 | 55 | 56 | 57 | 58 | 59 | 60 | 61 | 62 | 63 | 64 | 65 | 66 | 67 |
| LFNST set index | 17 | 16 | 15 | 14 | 13 | 12 | 11 | 10 | 9 | 8 | 7 | 6 | 5 | 4 | 3 | 2 | 2 |

| Intra pred. mode | 68 | 69 | 70 | 71 | 72 | 73 | 74 | 75 | 76 | 77 | 78 | 70 | 80 |
|---|---|---|---|---|---|---|---|---|---|---|---|---|---|
| LFNST set index | 2 | 2 | 2 | 2 | 2 | 2 | 2 | 2 | 2 | 2 | 2 | 2 | 2 |

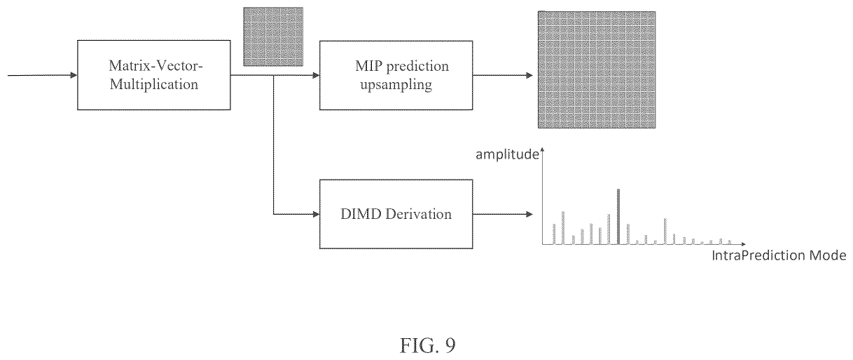

FIG. 9 illustrates an example of MIP prediction samples to build a HoG. For blocks using MIP prediction, the LFNST set index is derived as follows. Decoder-side intra mode derivation (DIMD) is used to derive the intra prediction mode of the current block based on the MIP predicted samples before upsampling. Specifically, a horizontal gradient and a vertical gradient are calculated for each predicted sample to build a HoG, as shown in FIG. 9. Then the intra prediction mode with the largest histogram amplitude values is used to determine the LFNST transform set and LFNST Transpose flag.

2.11 Subblock transform (SBT)

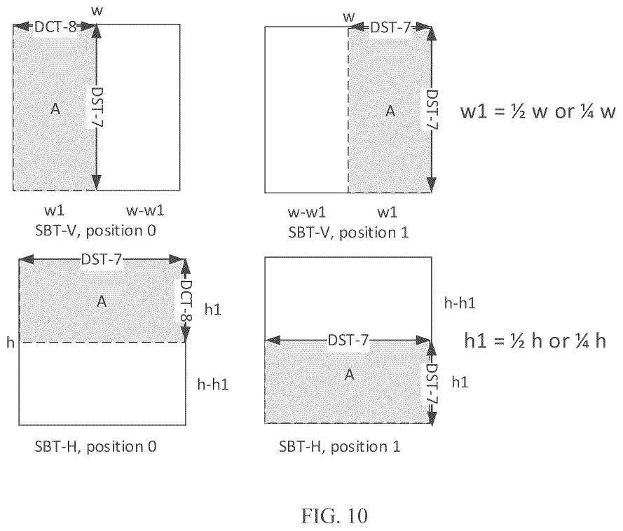

FIG. 10 illustrates an example of SBT position, type, and transform type. In VVC Test Model (VTM), subblock transform is introduced for an inter-predicted CU. In this transform mode, only a sub-part of the residual block is coded for the CU. When inter-predicted CU with cu_cbf equal to 1, cu_sbt_flag may be signaled to indicate whether the whole residual block or a sub-part of the residual block is coded. In the former case, inter MTS information is further parsed to determine the transform type of the CU. In the latter case, a part of the residual block is coded with inferred adaptive transform and the other part of the residual block is zeroed out.

When SBT is used for an inter-coded CU, SBT type and SBT position information are signaled in the bitstream. There are two SBT types and two SBT positions, as indicated in FIG. 10. For SBT-V (or SBT-H), the TU width (or height) may equal to half of the CU width (or height) or ¼ of the CU width (or height), resulting in 2:2 split or 1:3/3:1 split. The 2:2 split is like a binary tree (BT) split while the 1:3/3:1 split is like an asymmetric binary tree (ABT) split. In ABT splitting, only the small region contains the non-zero residual. If one dimension of a CU is 8 in luma samples, the 1:3/3:1 split along that dimension is disallowed. There are at most 8 SBT modes for a CU.

Position-dependent transform core selection is applied on luma transform blocks in SBT-V and SBT-H (chroma TB always using DCT-2). The two positions of SBT-H and SBT-V are associated with different core transforms. More specifically, the horizontal and vertical transforms for each SBT position is specified in FIG. 10. For example, the horizontal and vertical transforms for SBT-V position 0 is DCT-8 and DST-7, respectively. When one side of the residual TU is greater than 32, the transform for both dimensions is set as DCT-2. Therefore, the subblock transform jointly specifies the TU tiling, cbf, and horizontal and vertical core transform type of a residual block.

The SBT is not applied to the CU coded with combined inter-intra mode.

### 2.12 Non-Separable Primary Transform for Intra Coding

DCT-II plus LFNST transform combination is replaced by non-separable primary transform (NSPT) for certain block sizes.

All NSPT kernels comprises 35 sets and 3 candidates (similar to the current LFNST) with the following shapes:

$$\cdot NSPT 4 \times 4 \text{:} 16 \times 16$$

$$\cdot NSPT 4 \times 8 / NSPT 8 \times 4 \text{:} 32 \times 20$$

$$\cdot NSPT 8 \times 8 \text{:} 64 \times 32$$

$$\cdot NSPT 4 \times 16 / NSPT 16 \times 4 \text{:} 64 \times 24$$

$$\cdot NSPT 8 \times 16 / NSPT 16 \times 8 \text{:} 128 \times 40$$

Therefore, 12, 32, 40 and 88 coefficients are zeroed out using NSPT4×8/NSPT8×4, NSPT8×8, NSPT4×16/NSPT16×4 and NSPT8×16/NSPT16×8 respectively.

DCT-II plus LFNST transform combination is replaced with NSPT for the block shapes 4×4, 4×8, 8×4, 8×8, 4×16, 16×4, 8×16, and 16×8.

2.13 IBC with Template Matching (IBC-TM)

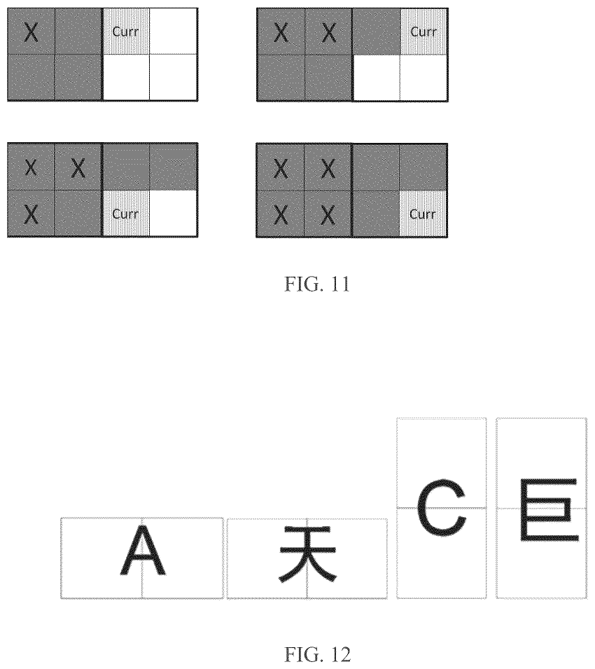

FIG. 11 illustrates an example of IBC reference regions depending on current CU position. It is proposed to also use Template Matching (TM) with IBC for both IBC merge mode and IBC AMVP mode.

The IBC-TM merge list has been modified compared to the one used by regular IBC merge mode such that the candidates are selected according to a pruning method with a motion distance between the candidates as in the regular TM merge mode. The ending zero motion fulfillment (which is a nonsense regarding Intra coding) has been replaced by motion vectors to the left (−W, 0), top (0, −H) and top-left (−W, −H) CUs, then, if necessary, the list is fulfilled with the left one without pruning.

In the IBC-TM merge mode, the selected candidates are refined with the Template Matching method prior to the RDO or decoding process. The IBC-TM merge mode has been put in competition with the regular IBC merge mode and a TM-merge flag is signaled.

In the IBC-TM AMVP mode, up to 3 candidates are selected from the IBC merge list. Each of those 3 selected candidates are refined using the Template Matching method and sorted according to their resulting Template Matching cost. Only the 2 first ones are then considered in the motion estimation process as usual.

The Template Matching refinement for both IBC-TM merge and AMVP modes is quite simple since IBC motion vectors are constrained to be integer and within a reference region as shown in FIG. 11. So, in IBC-TM merge mode, all refinements are performed at integer precision, and in IBC-TM AMVP mode, they are performed either at integer or 4-pel precision. In both cases, the refined motion vectors in each refinement step must respect the constraint of the reference region.

2.14 IBC Merge Mode with Block Vector Differences (IBC-MBVD)

IBC merge mode with block vector differences is shown as follows.

The distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.

The base candidates are selected from the first five candidates in the reordered IBC merge list. And based on the sum of absolute differences (SAD) cost between the template (one row above and one column left to the current block) and its reference for each refinement position, all the possible merge mode with block vector difference (MBVD) refinement positions (20×4) for each base candidate are reordered. Finally, the top 8 refinement positions with the lowest template SAD costs are kept as available positions, consequently for MBVD index coding.

### 2.15 Reconstruction-Reordered IBC (RR-IBC)

FIG. 12 illustrates examples of symmetry in screen content pictures. Screen content coding tools like Intra Block Copy (IBC) generate a prediction block by directly copying a prior coded reference region in the same picture. Symmetry is often observed in video content, especially in text character regions and computer-generated graphics in screen content sequences, as shown in FIG. 12. Therefore, a specific screen content coding tool considering the symmetry would be efficient to compress such kinds of video contents.

A Reconstruction-Reordered IBC (RR-IBC) mode is proposed for screen content video coding. When it is applied, the samples in a reconstruction block are flipped according to a flip type of the current block. At the encoder side, the original block is flipped before motion search and residual calculation, while the prediction block is derived without flipping. At the decoder side, the reconstruction block is flipped back to restore the original block.

Two flip methods, horizontal flip and vertical flip, are supported for RR-IBC coded blocks. A syntax flag is firstly signalled for an IBC AMVP coded block, indicating whether the reconstruction is flipped, and if it is flipped, another flag is further signaled specifying the flip type. For IBC merge, the flip type is inherited from neighboring blocks, without syntax signalling. Considering the horizontal or vertical symmetry, the current block and the reference block are normally aligned horizontally or vertically. Therefore, when a horizontal flip is applied, the vertical component of the BV is not signaled and inferred to be equal to 0. Similarly, the horizontal component of the BV is not signaled and inferred to be equal to 0 when a vertical flip is applied.

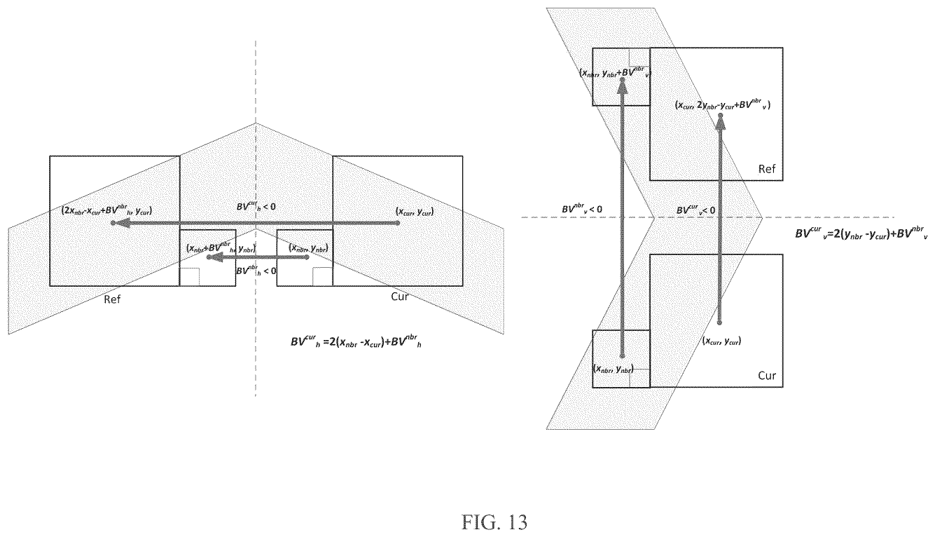

FIG. 13 illustrates example block vector (BV) adjustments for a horizontal flip and a vertical flip. To better utilize the symmetry property, a flip-aware BV adjustment approach is applied to refine the block vector candidate. For example, as shown in FIG. 13, (x_{nbr}, y_{nbr}) and (x_{cur}, y_{cur}) represent the coordinates of the center sample of the neighboring block and the current block, respectively, BV^{nbr} and BV^{cur} denotes the BV of the neighboring block and the current block, respectively. Instead of directly inheriting the BV from a neighboring block, the horizontal component of BV^{cur} is calculated by adding a motion shift to the horizontal component of BV^{nbr} (denoted as BV^{nbr}ₕ) in case that the neighboring block is coded with a horizontal flip, i.e., BV^{cur}ₕ=2 (x_{nbr}−x_{cur})+BV^{nbr}ₕ. Similarly, the vertical component of BV^{cur} is calculated by adding a motion shift to the vertical component of BV^{nbr} (denoted as BV^{nbr}ᵥ) in case that the neighboring block is coded with a vertical flip, i.e., BV^{cur}ᵥ=2 (y_{nbr}−y_{cur})+BV^{nbr}ᵥ.

### 2.16 Intra Template Matching

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

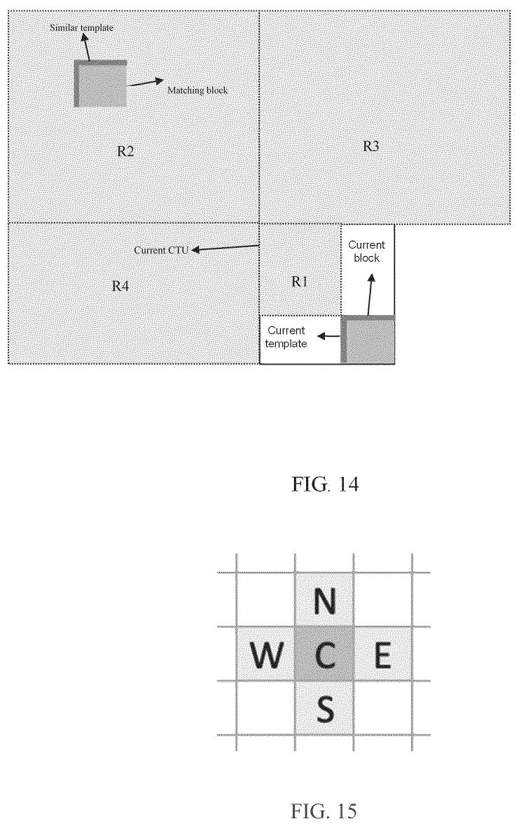

FIG. 14 illustrates an example of intra template matching search area. The prediction signal is generated by matching the L-shaped causal neighbor of the current block with another block in a predefined search area in FIG. 14 comprising:
R1: current CTU
R2: top-left CTU
R3: above CTU
R4: left CTU

SAD is used as a cost function. Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

$$SearchRange\_w = a * BlkW$$

$$SearchRange\_h = a * BlkH$$

Where ‘a’ is a constant that controls the gain/complexity trade-off. In practice, ‘a’ is equal to 5.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

### 2.17 Convolutional Cross-Component Model (CCCM) for Intra Prediction

It is proposed to apply convolutional cross-component model (CCCM) to predict chroma samples from reconstructed luma samples in a similar spirit as done by the current CCLM modes. As with CCLM, the reconstructed luma samples are down-sampled to match the lower resolution chroma grid when chroma sub-sampling is used.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### 12.17.1 Convolutional Filter

FIG. 15 illustrates an example spatial part of the convolutional filter. The proposed convolutional 7-tap filter comprises a 5-tap plus sign shape spatial component, a nonlinear term and a bias term. The input to the spatial 5-tap component of the filter comprises a center (C) luma sample which is collocated with the chroma sample to be predicted and its above/north (N), below/south(S), left/west (W) and right/east (E) neighbors as illustrated below in FIG. 15.

The nonlinear term P is represented as power of two of the center luma sample C and scaled to the sample value range of the content:

$$P = ( C * C + midVal ) >> bitDepth$$

That is, for 10-bit content P is calculated as:

$$P = ( C * C + 5 \; 12 ) >> 10$$

The bias term B represents a scalar offset between the input and output (similarly to the offset term in CCLM) and is set to middle chroma value (512 for 10-bit content).

Output of the filter is calculated as a convolution between the filter coefficients ci and the input values and clipped to the range of valid chroma samples:

$$predChromaVal = c 0 C + c 1 N + c 2 S + c 3 E + c 4 W + c 5 P + c 6 B$$

### 2.17.2 Calculation of Filter Coefficients

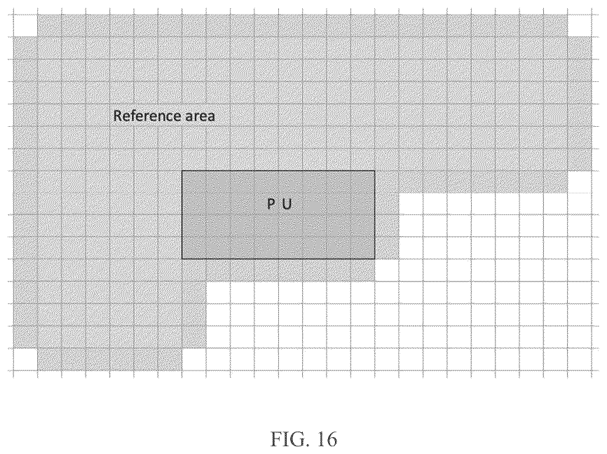

FIG. 16 illustrates an example reference area with paddings used to derive filter coefficients. The filter coefficients ci are calculated by minimizing mean squared error (MSE) between predicted and reconstructed chroma samples in the reference area. FIG. 16 illustrates the reference area which comprises 6 lines of chroma samples above and left of the PU. The reference area extends one PU width to the right and one PU height below the PU boundaries. The area is adjusted to include only available samples. The extensions to the area shown in darker grey are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in error correction models (ECM), however LDL decomposition was chosen instead of Cholesky decomposition to avoid using square root operations. The proposed approach uses only integer arithmetic.

### 2.17.3 Bitstream Signalling

Usage of the mode is signalled with a context-adaptive binary arithmetic coding (CABAC) coded PU level flag. One new CABAC context was included to support this. When it comes to signalling, CCCM is considered a sub-mode of CCLM. That is, the CCCM flag is only signalled if intra prediction mode is LM_CHROMA_IDX (to enable single mode CCCM) or MMLM_CHROMA_IDX (to enable multi-model CCCM).

### 2.18 Temporal Block Vector Prediction

Temporal BV prediction (TBVP) is proposed to mimic temporal motion vector prediction (TMVP). Temporal BV candidates are introduced to IBC merge/AMVP candidate lists. The IBC merge candidate list includes the regular IBC merge candidate list, the IBC-TM merge candidate list and IBC-MBVD base candidate list.

TBVP candidates are derived with full pruning from the same temporal positions as TMVP. They are put before the HMVP candidates.

### 2.19 Copy-Padding for IBC

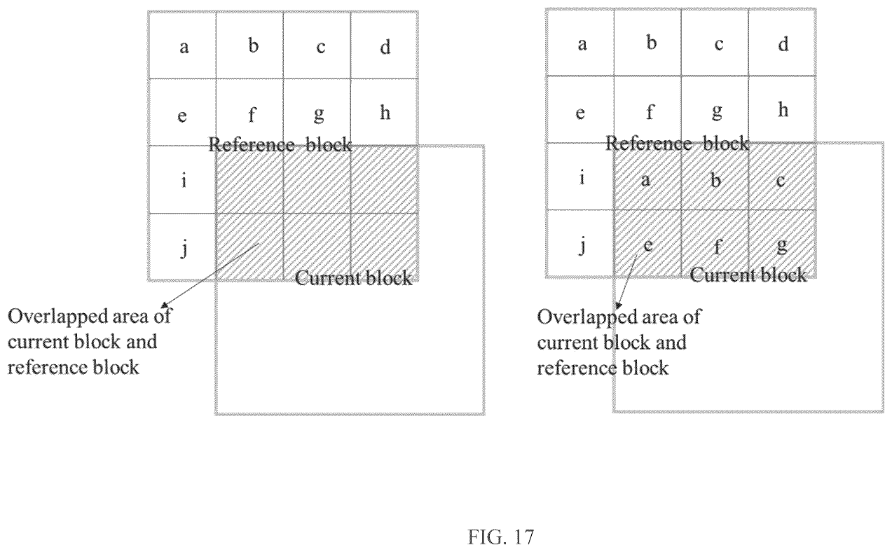

Copy-padding can be applied on the overlapped area. FIG. 17 illustrates an example of unreconstructed samples, depicted by shading, in a reference block being padded by copying their prediction samples. With copy-padding, an unreconstructed sample in the overlapped region can be padded by copying its prediction sample, as shown in FIG. 17, in an equation way,

$${P}^{′} ( x , y ) = P ( x + BVx , y + BVy )$$

wherein P′ (x,y) is a padded sample at position (x, y), P (x+BVx, y+BVy) is a prediction sample, and (BVx, BVy) is the BV of current block.

Copy-padding is performed only if the horizontal BV component is smaller than or equal to 0 and the vertical BV component is smaller than or equal to 0.

### 3. Technical Problems Addressed by Disclosed Embodiments

In example designs for IBC, DCT2 is used as the only transform kernel for blocks coded with IBC. However, other transform tools are used for blocks coded with intra prediction or inter prediction, such as LFNST, MTS, SBT, and NSPT.

5. A listing of Solutions and Embodiments

To address the above-described problems, methods as summarized below are disclosed. The embodiments should be considered as examples to explain the general concepts and should not be interpreted in a narrow way. Furthermore, these embodiments can be applied individually or combined in any manner.

In this disclosure, intra block copy (IBC) may not be limited to the current IBC technology, but may be interpreted as the technology that reference (or prediction) block is obtained with samples in the current slice/tile/subpicture/picture/other video unit (e.g., CTU row) excluding the conventional intra prediction methods. For example, it may refer to intra prediction with template matching (intraTMP). For another example, it may refer to direct block vector (DBV) mode.

In the following discussion, IBC may be replaced by other coding tools that rely on coded/decoded/reconstructed information within the same region, e.g., palette, intra template matching.

### Transform for IBC

1. It is proposed that one or more transform method/kernel may be used for a video unit coded with IBC.
   a. In one example, one or more intra prediction modes (IPM) are derived or signalled for the video unit, and the IPM may be used for the determination of transform for IBC.
      i. In one example, the IPM may be derived using DIMD/template-based intra mode derivation (TIMD).
      ii. In one example, the IPM may be derived using block vector.
      iii. In one example, the IPM may be derived based on block content/characteristics (such as gradients, colors, illuminance, and etc.).
   b. In one example, the transform method may refer to primary transform, such as MTS, NSPT.
   c. In one example, the transform method may refer to secondary transform, such as LFNST.
   d. In one example, the transform method may refer to subblock based transform, such as SBT.
   e. In one example, the transform method may refer to a separable transform (such as DST7, DCT8,DCT5, DST4, DST1, etc.).
   f. In one example, the transform method may refer to a non-separable transform (such as KLT, LFNST, NSPT, etc.).
   g. In one example, the transform method may refer to separable KLT.
   h. In one example, the transform method may refer to non-separable KLT.
   i. In one example, the transform method may refer to other transform methods that used for other coding tools (e.g., intra prediction tools, or inter prediction tools).
   j. In one example, whether to and/or how to perform transform for IBC may be same as that for intra/inter prediction.
      i. In one example, the transform set and/or the transform kernels may be same.
         1) In one example, the number of the transform sets may be same.
         2) In one example, the number of the transform kernels may be same.
         3) In one example, the determination of transform set or the transform kernel may be same.
         a) In one example, the IPM may be used for the determination of transform set or kernel.
      ii. In one example, the block size settings (e.g., minimum/maximum size) of the transform for IBC may be same as that for intra/inter prediction.
      iii. In one example, the determination of transform for IBC may be same as that for intra/inter prediction.
      iv. In one example, whether to and/or how to signal the transform for IBC may be same as that for intra/inter prediction.
      v. In one example, whether to and/or how to perform SBT for IBC may be same as SBT for inter/intra prediction.
         1) In one example, the way to divide the video unit into subblocks (e.g., SBT type) may be same.
         2) In one example, the way to determine the subblock position information (e.g., SBT position information) may be same.
   k. Alternatively, whether to and/or how to perform the transform for IBC may be different from that for intra/inter prediction.
      i. In one example, the transform set and/or the transform kernels may be different.
         1) In one example, the number of the transform sets may be different.
         2) In one example, the number of the transform kernels may be different.
         3) In one example, the determination of transform set or the transform kernel may be different.
      ii. In one example, the block size settings (e.g., minimum/maximum size) of the transform for IBC may be different from that for intra/inter prediction.
      iii. In one example, the determination of transform for IBC may be different from that for intra/inter prediction.
      iv. In one example, whether to and/or how to signal the transform for IBC may be different from that for intra/inter prediction.
      v. In one example, whether to and/or how to perform SBT for IBC may be different from SBT for inter/intra prediction.
         1) In one example, the way to divide the video unit into subblocks (e.g., SBT type) may be different.
      vi. In one example, the way to determine the subblock position information (e.g., SBT position information) may be different.
   l. In one example, one or more transform kernels may be used for IBC.
      i. In one example, the transform kernel may refer to MTS kernels.
         1) In one example, the transform kernel may refer to DCT kernels, such as DCT-M, wherein M is an integer larger than 0.
         a) In one example, DCT-1/DCT-2/DCT-3/DCT-4/DCT-5/DCT-6/DCT-7/DCT-8 may be used.
         2) In one example, the transform kernel may refer to DST kernels, such as DST-N, wherein N is an integer larger than 0.
         a) In one example, DST-1/DST-2/DST-3/DST-4/DST-5/DST-6/DST-7/DST-8may be used.
         3) In one example, one or more transform kernels which are not used in MTS for intra/inter prediction may be used for IBC.
      ii. In one example, the transform kernel may refer to LFNST kernels.
         1) In one example, one or more transform kernels may be retrained for IBC.
      iii. In one example, the transform kernel may refer to NSPT kernels.
         1) In one example, one or more transform kernels may be retrained for IBC.
      iv. In one example, one or more transform kernels used for other coding tools (e.g., intra/inter prediction) may be used.
         1) In one example, one or more transform kernels used for intra/inter prediction may be used for IBC.
         2) In one example, all transform kernels used for other coding tools may be used.
   m. In one example, the maximum/minimum transform size for IBC may be set same as other coding tools.
      i. Alternatively, the maximum/minimum transform size for IBC may be set individually.
      ii. In one example, the maximum/minimum transform size for IBC may be pre-defined, or signalled, or derived.
      iii. In one example, how to set the maximum/minimum transform size for IBC may depend on video content, such as screen content or camera-captured content.
   n. In one example, zero-out may be used for the transform for IBC.
      i. In one example, zero-out may be used in the primary transform for IBC.
      ii. In one example, zero-out may be used in the secondary transform for IBC.
      iii. In one example, zero-out may be used in the subblock based transform for IBC.
      iv. Alternatively, zero-out may not be used for the transform for IBC.
      v. For example, whether to apply zero-out for an IBC coded video unit may be dependent on the type of transform kernel/matrix.
      vi. For example, whether to apply zero-out for an IBC coded video unit may be dependent on block dimensions (such as block width and/or height).
2. In one example, when more than one transform methods are used for IBC, a first transform is disallowed to be used together with a second transform, wherein the first transform is different from the second transform.
   a. In one example, the first transform may refer to MTS/NSPT/LFNST/SBT, etc.
   b. In one example, the second transform may refer to MTS/NSPT/LFNST/SBT, etc.
   c. Alternatively, at least two of the transform methods may be allowed to be used together.
3. In one example, whether to and/or how to apply transform for the video unit coded with IBC may be signalled.
   a. In one example, one or more syntax elements may be signalled to indicate whether a specific transform is used.
      i. In one example, the specific transform may refer to MTS/NSPT/LFNST/SBT.
   b. In one example, one or more syntax elements may be signalled to indicate which transform set is used.
   c. In one example, one or more syntax elements may be signalled to indicate which transform kernel may be used.
   d. In one example, the syntax elements above may be binarized with fixed length coding, or truncated unary coding, or unary coding, or exponential Golomb (EG) coding, or a coded flag.
      i. In one example, the syntax element may be bypass coded.
      ii. Alternatively, the syntax element may be context coded.
         1) The context may depend on coded information, such as block dimensions, and/or block size, and/or slice/picture types, and/or the information of neighboring blocks (adjacent or non-adjacent), and/or the information of other coding tools used for current block, and/or the information of temporal layer.
   e. In one example, whether to and/or how to apply transform for the video unit coded with IBC may be determined by a syntax element (SE) which also indicates another kind of information.
      i. For example, the SE may also indicate the precision of MV or MMVD.
4. In one example, whether to and/or how to apply transform for the video unit coded with IBC may be pre-defined or determined.
   a. In one example, the determination of whether to and/or how to apply the transform may depend on coding information, such as:
      i. whether a specific coding tool is allowed;
      ii. block dimensions and/or block size;
      iii. the depth of a block;
      iv. slice/picture type and/or partition tree type (single, or dual tree, or local dual tree);
      v. block location; and/or
      vi. color component.
   b. In one example, the determination of transform kernel may be derived.
      i. In one example, the determination may depend on coding information.
         1) In one example, the coding information may refer to block size/dimensions.
         2) In one example, the coding information may refer to IPM.
         3) In one example, the coding information is used to determine the transform kernel of LFNST/NSPT/MTS/SBT, etc.
   c. In one example, the information of transform of one or more neighboring (adjacent or non-adjacent) video units may be reused for the current video unit coded with IBC.
      i. In one example, the neighboring video units may be coded with IBC.
5. In one example, whether to and/or how to apply a specific transform for the video unit coded with IBC may depend on color format/color component.
   a. In one example, the specific transform may refer to LFNST/NSPT/MTS/SBT, etc.
   b. In one example, the transform may apply to all color components.
      i. Alternatively, the transform may be not allowed to be applied to chroma components.
      ii. For example, whether to apply a certain transform to chroma components may be dependent on dual tree coding and/or single tree coding.
   c. In one example, whether to and/or how to apply the transform to a first component may depend on whether to apply the transform to a second component.
      i. In one example, the first component may refer to Cb and/or Cr in YCbCr color space, and the second component may refer to Y.
      ii. In one example, the first component may refer to Y in YCbCr color space, and the second component may refer to Cb and/or Cr.
      iii. In one example, the first component may refer to R and/or B in RGB color space, and the second component may refer to G.
      iv. In one example, the first component may refer to G in RGB color space, and the second component may refer to R and/or B.
   d. In one example, the minimum/maximum block size for the transform may depend on color format.
      i. In one example, the color format may refer to 4:2:0/4:2:2/4:4:4.
      ii. Alternatively, the minimum/maximum block size for the transform may be independent from the color format.
   e. For example, the minimum/maximum block size for a transform may be pre-defined.
   f. For example, the minimum/maximum block size for different transforms may be different.
6. In one example, whether to and/or how to apply a specific transform for the video unit coded with IBC may depend on whether screen content or cameral-captured contents are coded/decoded.
   a. It may be signaled or inferred by the decoder whether screen content or cameral-captured contents are coded/decoded.
7. In one example, whether to and/or how to apply a specific transform for the video unit coded with IBC may depend on whether and/or how IBC prediction is combined with at least one other prediction method.
   a. The other prediction method may be inter-prediction.
   b. The other prediction method may be intra-prediction.
   c. The other prediction method may be IBC.
   d. The “combination” may refer to a weighted sum.
8. In one example, whether to and/or how to apply a specific transform for the video unit coded with IBC may depend on the precision of the BV.
   a. In one example, whether to and/or how to apply a specific transform for the video unit coded with IBC may depend on whether a fractional BV is used.
9. In one example, whether to and/or how to apply a specific transform for the video unit coded with IBC may depend on whether the IBC prediction is further refined.
   a. For example, the IBC prediction may be further refined by LIC.
   b. For example, the IBC prediction may be further refined by PDPC.
10. In one example, “IBC” mentioned in above examples may refer to IntraTMP or other coding tools as variants of IBC.
11. In one example, SBT may be used for intra prediction.
12. In one example, LFNST or NSPT may be used for inter prediction.

### General Examples

13. In above examples, the video unit may refer to the color component/sub-picture/slice/tile/coding tree unit (CTU)/CTU row/groups of CTU/coding unit (CU)/prediction unit (PU)/transform unit (TU)/coding tree block (CTB)/coding block (CB)/prediction block (PB)/transform block (TB)/a block/sub-block of a block/sub-region within a block/any other region that contains more than one sample or pixel.
14. Whether to and/or how to apply the disclosed methods above may be signalled at sequence level/group of pictures level/picture level/slice level/tile group level, such as in sequence header/picture header/sequence parameter set (SPS)/video parameter set (VPS)/decoding parameter set (DPS)/decoding capability information (DCI)/picture parameter set (PPS)/adaptation parameter set (APS)/slice header/tile group header.
15. Whether to and/or how to apply the disclosed methods above may be signalled at PB/TB/CB/PU/TU/CU/VPDU/CTU/CTU row/slice/tile/sub-picture/other kinds of region contains more than one sample or pixel.
16. Whether to and/or how to apply the disclosed methods above may be dependent on coded information, such as block size, color format, single/dual tree partitioning, color component, slice/picture type.

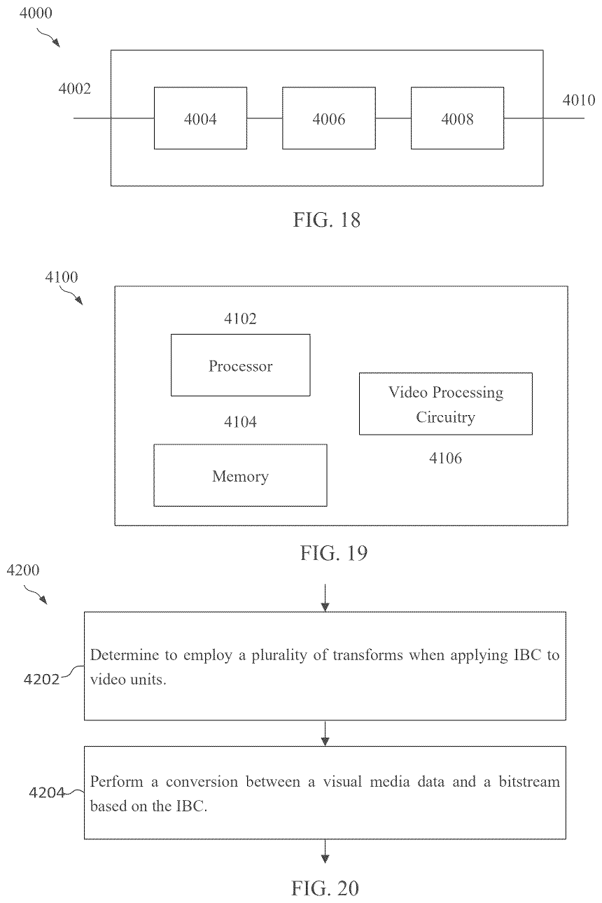

FIG. 18 is a block diagram showing an example video processing system 4000 in which various embodiments disclosed herein may be implemented. Various implementations may include some or all of the components of the system 4000. The system 4000 may include input 4002 for receiving video content. The video content may be received in a raw or uncompressed format, e.g., 8-or 10-bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present disclosure. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or DisplayPort, and so on. Examples of storage interfaces include serial advanced technology attachment (SATA), peripheral component interconnect (PCI), integrated drive electronics (IDE) interface, and the like. The embodiments described in the present disclosure may be embodied in various electronic devices such as mobile phones, laptops, smartphones or other devices that are capable of performing digital data processing and/or video display.

FIG. 19 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present disclosure. The memory (memories) 4104 may be used for storing data and code used for implementing the methods and embodiments described herein. The video processing circuitry 4106 may be used to implement, in hardware circuitry, some embodiments described in the present disclosure. In some embodiments, the video processing circuitry 4106 may be at least partly included in the processor 4102, e.g., a graphics co-processor.

FIG. 20 is a flowchart for an example method 4200 of video processing. The method 4200 includes determining to employ a plurality of transforms when applying intra block copy (IBC) to video units at step 4202. A conversion is performed between a visual media data and a bitstream based on the IBC at step 4204. The conversion of step 4204 may include encoding at an encoder or decoding at a decoder, depending on the example.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

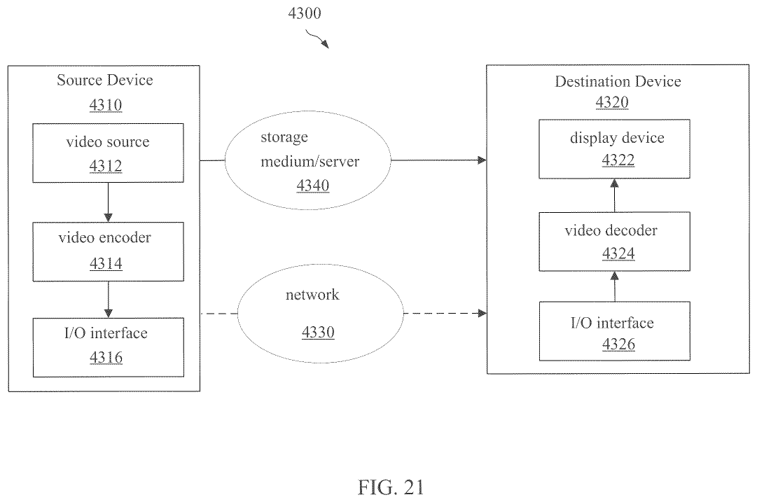

FIG. 21 is a block diagram that illustrates an example video coding system 4300 that may utilize the embodiments of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the HEVC standard, VVC standard, and other current and/or further standards.

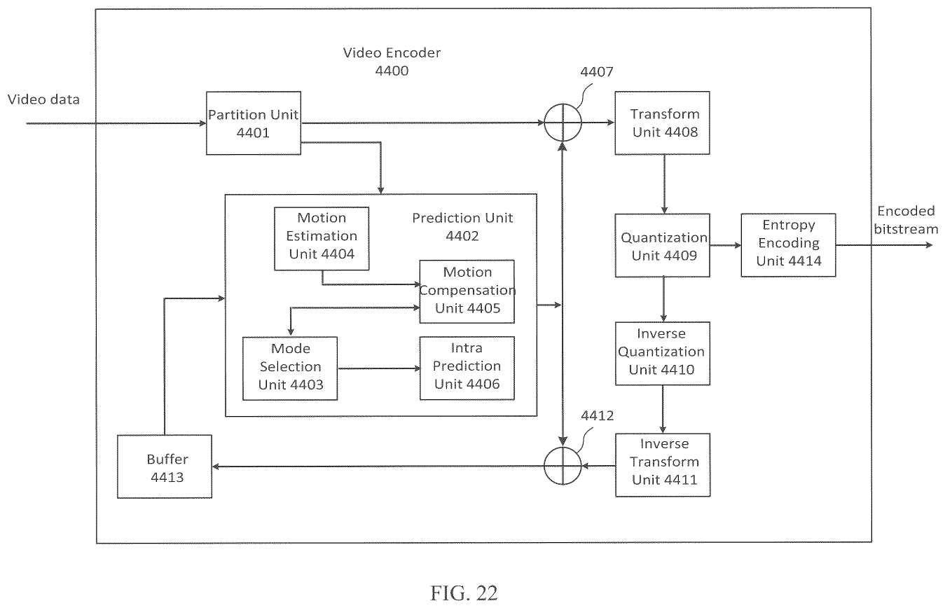

FIG. 22 is a block diagram illustrating an example of video encoder 4400, which may be video encoder 4314 in the system 4300 illustrated in FIG. 21. Video encoder 4400 may be configured to perform any or all of the embodiments of this disclosure. The video encoder 4400 includes a plurality of functional components. The embodiments described in this disclosure may be shared among the various components of video encoder 4400. In some examples, a processor may be configured to perform any or all of the embodiments described in this disclosure.

The functional components of video encoder 4400 may include a partition unit 4401; a prediction unit 4402, which may include a mode select unit 4403, a motion estimation unit 4404, a motion compensation unit 4405, and an intra prediction unit 4406; a residual generation unit 4407; a transform processing unit 4408; a quantization unit 4409; an inverse quantization unit 4410; an inverse transform unit 4411; a reconstruction unit 4412; a buffer 4413; and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

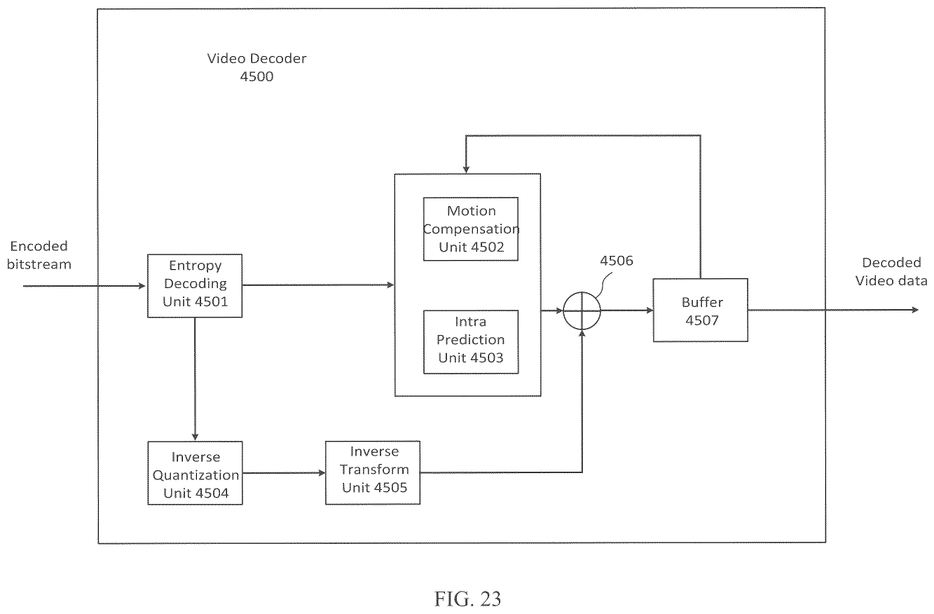

FIG. 23 is a block diagram illustrating an example of video decoder 4500 which may be video decoder 4324 in the system 4300 illustrated in FIG. 21. The video decoder 4500 may be configured to perform any or all of the embodiments of this disclosure. In the example shown, the video decoder 4500 includes a plurality of functional components. The embodiments described in this disclosure may be shared among the various components of the video decoder 4500. In some examples, a processor may be configured to perform any or all of the embodiments described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

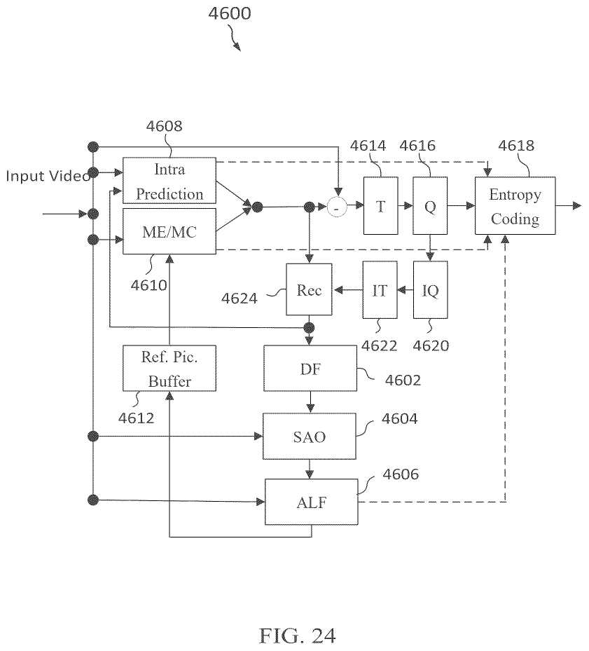

FIG. 24 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of embodiments discussed herein.

1. A method for processing video data comprising: determining to employ a plurality of transforms when applying intra block copy (IBC) to video units; and performing a conversion between a visual media data and a bitstream based on the IBC.

2. The method of solution 1, wherein one or more intra prediction modes (IPMs) are used to determine the transforms.

3. The method of any of solutions 1-2, wherein the transforms include a primary transform, a secondary transform, a subblock based transform, a separable transform, a non-separable transform, or combinations thereof.

4. The method of any of solutions 1-3, wherein the transforms include multiple transform selection (MTS), non-separable primary transform (NSPT), low-frequency non-separable transform (LFNST), subblock transform (SBT), discrete sine transform (DST), discrete cosine transform (DCT), separable Karhunen-Loève transform (KLT), non-separable KLT, a zero out transform, or combinations thereof.

5. The method of any of solutions 1-4, wherein one or more transform kernels are used for IBC.

6. The method of any solutions 1-5, wherein the kernels include a MTS kernel, a DCT kernel, a DST kernel, a LFNST kernel, a NSPT kernel, or combinations thereof.

7. The method of any solutions 1-6, wherein a minimum transform size and a maximum transform size are used for IBC, and wherein the minimum transform size and the maximum transform size are set individually, predefined, signaled, derived, set based on video content, or combinations thereof.

8. The method of any of solutions 1-7, wherein when more than one transform is used for IBC, a first transform is disallowed for use with a second transform.

9. The method of any of solutions 1-8, wherein the bitstream includes one or more syntax elements indicating whether a specific transform is used, which transform is used, which transform kernel is used, how to apply a transform, a precision of motion vector (MV), a precision of a merge mode motion vector difference (MMVD), or combinations thereof.

10. The method of any of solutions 1-9, wherein application of a transform depends on coding information.

11. The method of any of solutions 1-10, wherein determination of a transform kernel is derived based on coding information.

12. The method of any of solutions 1-11, wherein transform information related to a neighboring video unit is reused to for a current video unit.

13. The method of any of solutions 1-12, wherein a transform applies to all color components.

14. The method of any of solutions 1-13, wherein application of a transform to a first component depends on application of the transform to a second component.

15. The method of any of solutions 1-14, wherein a minimum block size or a maximum block size of a transform depends on color format.

16. The method of any of solutions 1-15, wherein application of a specific transform depends on whether video content is coded or decoded.

17. The method of any of solutions 1-16, wherein application of a specific transform depends on whether IBC prediction is combined with inter prediction or intra prediction.

18. The method of any of solutions 1-17, wherein application of a specific transform for a video unit coded with IBC depends on a precision of a block vector (BV).

19. The method of any of solutions 1-18, wherein application of a specific transform for a video unit coded with IBC depends on whether IBC prediction is further refined by local illumination compensation (LIC) or position dependent prediction combination (PDPC).

20. An apparatus for processing video data comprising: a processor; and a non-transitory memory with instructions thereon, wherein the instructions upon execution by the processor, cause the processor to perform the method of any of solutions 1-19.

21. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-19.

22. A non-transitory computer-readable recording medium storing a bitstream of a video which is generated by a method performed by a video processing apparatus, wherein the method comprises: determining to employ a plurality of transforms when applying intra block copy (IBC) to video units; and generating the bitstream based on the determining.

23. A method for storing bitstream of a video comprising: determining to employ a plurality of transforms when applying intra block copy (IBC) to video units; generating the bitstream based on the determining; and storing the bitstream in a non-transitory computer-readable recording medium.

24. A method, apparatus, or system described in the present disclosure.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present disclosure, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field-programmable gate array (FPGA) or an application-specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of the present disclosure. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing video data, comprising:
determining to employ one or more transform methods or one or more transform kernels to a video unit when applying an intra block copy (IBC) to the video unit; and
performing a conversion between a visual media data comprising the video unit and a bitstream of the visual media data based on the determining.

2. The method of claim 1, wherein one or more intra prediction modes (IPMs) are derived or signalled for the video unit, and the IPMs are used to determine the one or more transform methods or the one or more transform kernels for the IBC, and
wherein either a) the IPMs are derived using decoder-side intra mode derivation (DIMD), template-based intra mode derivation (TIMD), or block vector; or b) the IPMs are derived based on block content, gradients, colors, or illuminance.

3. The method of claim 1, wherein the one or more transform methods include a primary transform, a secondary transform, a subblock based transform, a separable transform, a non-separable transform, or a combination thereof, or
wherein the one or more transform methods include multiple transform selection (MTS), non-separable primary transform (NSPT), low-frequency non-separable transform (LFNST), subblock transform (SBT), discrete sine transform (DST), discrete cosine transform (DCT), separable Karhunen-Loève transform (KLT), non-separable KLT, a zero out transform, or a combination thereof.

4. The method of claim 1, wherein whether to and/or how to perform the one or more transform methods or the one or more transform kernels for the IBC is the same as that for intra prediction mode or inter prediction mode, or
wherein whether to and/or how to perform the one or more transform methods or the one or more transform kernels for the IBC is different from that for intra prediction mode or inter prediction mode.

5. The method of claim 1, wherein the one or more transform kernels are used for the IBC, and
wherein the one or more transform kernels include a multiple transform selection (MTS) kernel, a discrete cosine transform (DCT) kernel, a discrete sine transform (DST) kernel, a low-frequency non-separable transform (LFNST) kernel, a non-separable primary transform (NSPT) kernel, kernels which are not used in the MTS kernel for intra/inter prediction, kernels used for intra/inter prediction, or a combination thereof.

6. The method of claim 1, wherein a minimum transform size and/or a maximum transform size for the IBC is set the same as that for other coding tools, and
wherein the minimum transform size and/or the maximum transform size for the IBC are set individually, predefined, signaled, derived, based on video content, or a combination thereof.

7. The method of claim 1, wherein coefficients of one or more transforms for the IBC are zeroed out, or
wherein coefficients of one or more transforms for the IBC are not zeroed out, or
wherein whether to apply zero-out for the video unit is dependent on a type of transform kernel, a type of transform matrix, or a block dimension.

8. The method of claim 1, wherein when more than one transform method is used for the IBC, a first transform is disallowed to be used together with a second transform,
wherein the first transform is different from the second transform, and
wherein the first transform or the second transform includes multiple transform selection (MTS), non-separable primary transform (NSPT), low-frequency non-separable transform (LFNST), or subblock transform (SBT).

9. The method of claim 1, wherein the bitstream includes one or more syntax elements indicating whether a specific transform is used, which transform set is used, which transform kernel is used, how to apply a transform for the video unit coded with the IBC, or a combination thereof, or
wherein the one or more syntax elements are binarized with fixed length coding, or truncated unary coding, or unary coding, or exponential Golomb (EG) coding, a coded flag, or a combination thereof, or
wherein the one or more syntax elements are bypass coded, context coded, or a combination thereof, or
whether to and/or how to apply a transform for the video unit coded with the IBC is determined by a syntax element (SE) which also indicates a precision of motion vector (MV) or a precision of a merge mode with motion vector difference (MMVD).

10. The method claim 1, wherein application of a transform for the video unit coded with the IBC is pre-defined or determined, or
wherein application of a transform for the video unit coded with the IBC depends on coding information, wherein the coding information comprises whether a specific coding tool is allowed, block dimension, a depth of a block, a slice/picture type, a partition tree type, a block location, a colour component, or a combination thereof.

11. The method of claim 1, wherein determination of a transform kernel is derived based on coding information, wherein the coding information comprises block dimension, an intra prediction mode (IPM), or a combination thereof, or
wherein information of a transform related to one or more neighboring video units of the video unit is reused to for the video unit coded with the IBC, wherein the one or more neighboring video units is coded with the IBC.

12. The method of claim 1, wherein whether to and/or how to apply a specific transform for the video unit coded with the IBC depends on a color format, a color component, or a combination thereof.

13. The method of claim 12, wherein the specific transform includes multiple transform selection (MTS), non-separable primary transform (NSPT), low-frequency non-separable transform (LFNST), subblock transform (SBT), or a combination thereof,
wherein a transform applies to all color components,
wherein application of a transform to a first color component depends on application of the transform to a second color component, or
wherein a minimum block size and/or a maximum block size of a transform depends on a color format.

14. The method of claim 1, wherein application of a specific transform for the video unit coded with the IBC depends on whether video content is coded or decoded, or
wherein application of a specific transform for the video unit coded with the IBC depends on whether IBC prediction is combined with inter prediction, intra prediction, IBC prediction, or a combination thereof, or
wherein application of a specific transform for the video unit coded with the IBC depends on a precision of a block vector (BV), or
wherein application of a specific transform for the video unit coded with the IBC depends on whether IBC prediction is further refined by local illumination compensation (LIC) or position dependent prediction combination (PDPC).

15. The method of claim 1, wherein the IBC includes intra prediction with template matching (intraTMP) or other coding tools as variants of the IBC.

16. The method of claim 1, wherein subblock transform (SBT) is applied for intra prediction, or wherein low-frequency non-separable transform (LFNST) or non-separable primary transform (NSPT) is applied for inter prediction.

17. The method of claim 1, wherein the conversion includes encoding the visual media data into the bitstream.

18. The method of claim 1, wherein the conversion includes decoding the visual media data from the bitstream.

19. An apparatus for processing video data comprising: a processor; and a non-transitory memory with instructions thereon, wherein the instructions upon execution by the processor, cause the processor to:
determine to employ one or more transform methods or one or more transform kernels to a video unit when applying an intra block copy (IBC) to the video unit; and
perform a conversion between a visual media data comprising the video unit and a bitstream of the visual media data based on the determination.

20. A non-transitory computer-readable recording medium storing a bitstream of a visual media data which is generated by a method performed by a video processing apparatus, wherein the method comprises:
determining to employ one or more transform methods or one or more transform kernels to a video unit when applying an intra block copy (IBC) to the video unit; and
generating the bitstream of the visual media data comprising the video unit based on the determining.
